(19) United States
(12) Patent Application Publication
(10) Pub. No.: US 2005/0024364 A1
(43) Pub. Date: Feb. 3, 2005

(54) High speed display processing apparatus

(75) Inventor: Akihisa Shouen, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/788,485

(22) Filed: Mar. 1, 2004

(30) Foreign Application Priority Data
Aug. 1, 2003 (JP) 2003-284754

(51) Int. Cl. G06T 1/00; G06F 15/00

(52) U.S. Cl. 345/501

(57) ABSTRACT

A server virtually simulates a high resolution image generated in a large-scale application by CAD, etc. in memory based on the assumption that the image is displayed on the display device of a client. A result of a display simulation is stored in the memory. Based on the stored data, image data to be transmitted to a client is generated and transmitted. On the client side, the display-simulated display data transmitted from the server is displayed.

### BACKGROUND OF THE INVENTION

1. Field of the Invention

The present invention relates to a high speed display processing apparatus, and more specifically to a high speed display processing apparatus for use in an engineering system application requiring large-scale basic processing, an ASP (application service provider) service in a visualization field, etc. for high speed display of a large-scale scientific technological computation result, an on-demand service field, etc.

1. Description of the Related Art

In the recent product development, it is necessary to develop a high-performance and quality product at a low cost in a short period and introduce the product to the market to successfully make a profit.

To attain this, the most important strategy is to generate an ASP system for reducing the entire TCO (total cost including the maintenance and management cost) by a user using high performance CAD (totally computer-aided design) software, etc. at a low cost anywhere at any time in the highest performance machine environment.

In the above-mentioned software on-demand environment, it is furthermore important to guarantee a high speed display technology which allows a server (provider) to quickly process all applications to be used and efficiently (reducing a network load) extract and transfer resultant display information, etc.

There is the conventional Patent Literature 1 developed as an invention for a large scale high speed network.

Conventionally, since there is a large amount of data communications between an application server and clients in the operation of a large-scale application system such as the CAD, etc., the operation is limited to a system for several or up to 10 clients in a relatively short distance. Additionally, even using broadband technologies, a stable operation is not guaranteed in the future in which a larger number of users are expected to simultaneously use the applications.

Patent Literature 1: Japanese Patent Application Laid-open No. Hei 3-255583

It is urgently necessary to generate an environment in which high performance CAD software, etc. can be used at a low cost anywhere at any time in the highest performance machine environment. However, with the conventional technology, large-scale applications, etc. such as CAD require an enormous amount of data to be transmitted and a serious time delay occurs when the data is simultaneously supplied to a number of remote users. As a result, the conventional technology is not up to practical use.

### SUMMARY OF THE INVENTION

The present invention aims at providing a high speed display processing apparatus capable of realizing high speed transfer and display by retrieving the information only visually significant as display information so that the amount of information to be transmitted can be reduced.

A high speed display processing system according to the present invention is for simulating in advance at a high speed on a server side only display data which can be visually recognized as a server-side visual simulation, and the system comprises: a display data extraction unit extracting each display data element of a display data set in a system for a long-haul transmission of the display data set from a server to a client; a higher display data subset extraction unit checking an overlap state between the display data elements, and extracting a portion of a higher display data element whose overlap state is to be displayed when the overlap state is detected; a calculation unit compressing or expanding the higher display data element corresponding to a significant size and resolution of a display device of the client, and calculating in advance coordinates of a two-dimensional display image of each display data element; a storage unit storing only visually recognized display data extracted using each of said units or composed by a calculation; and a transmission unit transmitting the composite display data read by said recognition unit to the client.

The high speed display processing apparatus according to the present invention is a display processing apparatus which converts generated original image data and transmits the converted data to a display device, and includes: an extraction unit for extracting only a display result on the display device as display data from the original image data; and a transmission unit for transmitting the display data to the display device.

According to the present invention, original image data is set in a visible state on the display device, and then transmitted to a display device. Therefore, the amount of image data to be transmitted can be considerably reduced. Accordingly, although a plurality of users request to display generated original image data over a network, there is a reduced amount of image data to be transmitted. Therefore, a sufficient number of users can be accommodated with the transfer capacity of an existing network.

According to the present invention, a network can be efficiently used, a large amount of image data can be, at a high speed, transferred and displayed by transferring only the data to be finally displayed depending on the display device of each user. Therefore, a very practical technology can be realized. Furthermore, since a server can centrally supply and manage high performance information resources, the convenience and productivity of users can be improved and the total cost can be reduced.

Furthermore, since the data transmitted over a network is a part of original image data, that is, the data reduced from the original image data and to be actually displayed, it does not indicate significant information although it is leaked during the transfer, thereby preventing the leakage of information.

### BRIEF DESCRIPTION OF THE DRAWINGS

FIG. 1 is an explanatory view of the first embodiment of the present invention;

FIG. 2 is an explanatory view of the second embodiment of the present invention;

FIG. 3 is an explanatory view of the third embodiment of the present invention;

FIG. 4 shows the concept of, at a high speed, performing the processes according to the first through third embodiments of the present invention in parallel with each other;

FIG. 5 is an explanatory view of the display simulation ;

FIG. 6 is a flowchart (1) for explanation of the process according to an embodiment of the present invention; and

FIG. 7 is a flowchart (2) for explanation of the process according to an embodiment of the present invention.

### DESCRIPTION OF THE PREFERRED EMBODIMENTS

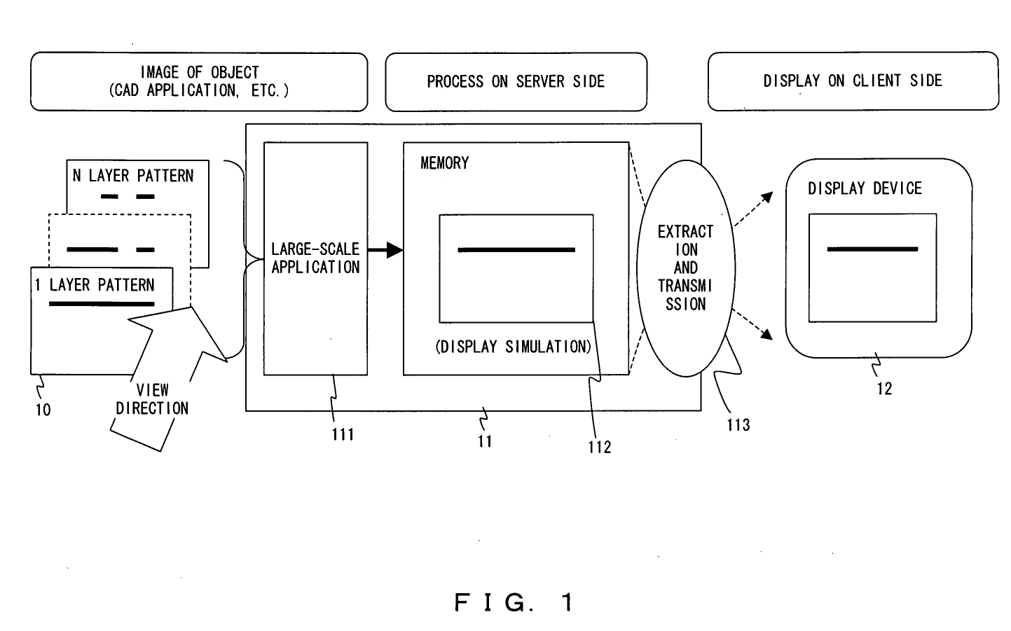

FIG. 1 is an explanatory view of the first embodiment of the present invention.

In the present invention, the amount of image data to be transferred can be reduced by a server simulating and extracting in advance at a high speed the only display data which can be visually recognized, thereby realizing high speed display.

FIG. 1 shows an image 10 of an object configured by a plurality of layers such as a printing plate, a system LSI, etc.

A server 11 provides a large-scale application 111 which is a CAD tool, etc. for generating the image and faithfully represents an image of an object. Display data is output from the CAD tool.

A display simulation unit 112 inputs the display data of the large-scale application, and virtually displays the data on the memory at a high speed. When there is display data overwritten later on the same coordinates, the last written data is valid.

An extracted and transmitted portion 113 shown in FIG. 1 is a portion extracted as a result of virtually displaying data (112) on the memory, and is to be transmitted to a client 12. The extracted data is obtained as a display result by overwriting data on the display, and only the surface or final data to be actually displayed as the display result is transferred, the amount of transmitted data is smaller, thereby increasing the transmission speed.

Since a display device 12 displays transmitted display data without overwriting data on the screen, a display result can be eventually obtained at a high speed and allow a user to visually recognize a displayed image at a higher speed.

That is, assume that a multi-layer pattern such as an image denoted by the reference numeral 10 in FIG. 1 is displayed on the display device of the client as viewed from the surface, and that the process indicated by the reference numeral 12 shown in FIG. 1 is performed in the following steps.

(1) Data up to one display unit data (until data is not received within a predetermined time) is to be overwritten in advance on the memory (11 shown in FIG. 1) of the server.

(2) Only pattern information as a display result is extracted.

(3) Only the data is transmitted to the client (12 shown in FIG. 1).

(4) The client receives and displays the data.

In the above-mentioned process, in the case of the data denoted by the reference numeral 10 shown in FIG. 1, the five thick lines are represented by one thick line, that is, the lines are 80% reduced.

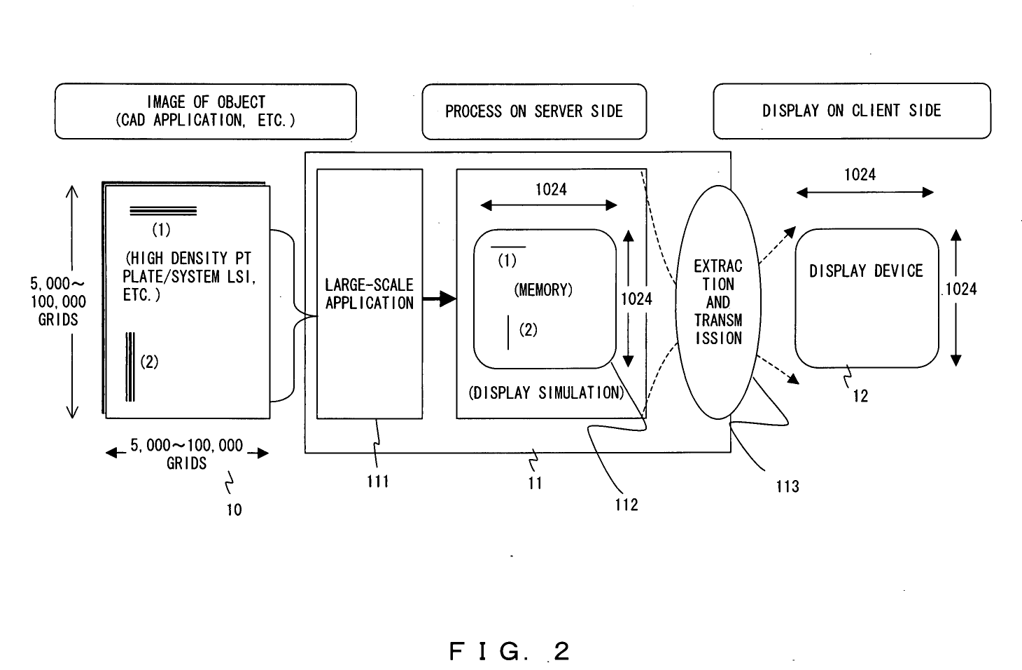

FIG. 2 is an explanatory view of the second embodiment of the present invention.

In the present embodiment, in addition to the process according to the first embodiment of the present invention, the optimum display data depending on the resolution or display size (resolution-dependence) of the display device of the client is quickly simulated and extracted by the server. As a result, the amount of image data to be transferred can be reduced, thereby realizing high speed display.

A reference numeral 10 shown in FIG. 2 denotes an image of an object configured by a plurality of layers such as a printing plate, a system LSI, etc. In this example, the image is configured by vertical and horizontal 5,000 through 100,000 grids.

A reference numeral 111 shown in FIG. 2 denotes a large-scale application which is a CAD tool, etc. for generating the image denoted by the reference numeral 10 and faithfully represents an image of an object. Display data is output from the tool. Therefore, an image generated by the CAD tool, etc. is configured by vertical and horizontal 5,000 through 100,000 grids.

The display simulation unit denoted by the reference numeral 112 shown in FIG. 2 inputs display data of a large-scale application 111, and virtually displays the data on the memory at a high speed. A rounding process is performed from an actual size of an object to a display size of the object depending on the optimum resolution for the display device and the display size. For example, in the case shown in FIG. 2, the resolution of the display device of the client is assumed to be 1,024×1,024. Therefore, lines drawn as separate lines at the resolution of 5,000˜100,000 grids can frequently be drawn as the line at the same coordinates on the displays device of the client. Therefore, when the same coordinates are indicated as a result of the display simulation of a display device of a client, a line overwritten later is a valid line until the next data is overwritten on the display device of a client. In the case of the image in the CAD application denoted by the reference numeral 10 shown in FIG. 2, the lines (1) and (2) drawn as three lines are drawn as each of the lines (1) and (2) when the lines are displayed on the memory in the display simulation of the server in accordance with the resolution of the display device 12 in the client.

An extracted and transmitted portion 112 shown in FIG. 2 is a portion extracted as a result of virtually displaying data on the memory, and is a portion of image data to be transmitted to the client. The extracted data is obtained as a result of overwriting data, and only the data to be actually displayed as a display result is transferred, the amount of transmitted data is smaller, thereby increasing the transmission speed.

Since a display device 12 shown in FIG. 2 displays transmitted display data without overwriting data on the screen, a display result can be eventually obtained at a high speed and allow a user to visually recognize a displayed image at a higher speed.

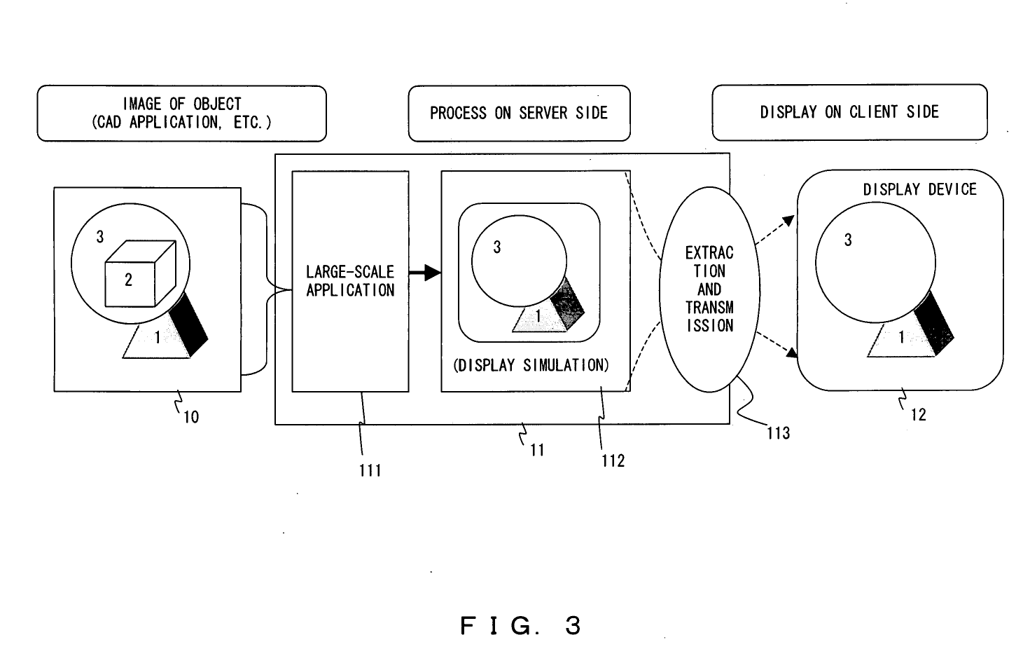

FIG. 3 is an explanatory view according to the third embodiment of the present invention.

The present embodiment is an example of an application of the method of the above-mentioned embodiment to graphic data. The amount of image data to be transferred can be reduced and the high speed display can be realized by a server displaying and simulating a display result at a high speed, and extracting image data to be transmitted to a client in advance. FIG. 3 shows the images displayed in the order from 1 to 3. A reference numeral 10 shown in FIG. 3 denotes the image displayed as 2- and 3-dimensional graphic data.

In FIG. 3 a large-scale application 111 is a CAD tool, etc. for generating the image denoted by the reference numeral 10 and faithfully represents an image of an object. Display data is output from the tool.

A display simulation unit 112 shown in FIG. 3 inputs the display data of the large-scale application 111, and virtually displays the data quickly on the memory. When the images are displayed in the order from 1 to 3, the second graphics 2 have the coordinates to be hidden behind the third graphics 3, and the second graphics 2 is overwritten later by the display data of the third graphics. Therefore, the graphic data 2 becomes invalid, and the graphic data 3 becomes valid An extracted and transmitted portion 113 shown in FIG. 3 is a portion extracted as a result of virtually displaying data on the memory, and is to be transmitted to a client. The extracted data is obtained as a result of overwriting data, and only the data to be actually displayed as a display result is transferred, the amount of transmitted data is smaller, thereby increasing the transmission speed.

Since a display device 12 shown in FIG. 3 displays transmitted display data without overwriting data on the screen, the amount of image data to be transferred can be eventually reduced, a display result can be obtained at a high speed, and a user is allowed to visually recognize a displayed image at a higher speed.

That is, assume that graphic data as an image denoted by the reference numeral 10 in FIG. 3 is displayed on the display device 12 of the client, and that the process is performed in the following steps.

(1) Data up to one display unit data (until data is not received within a predetermined time) is to be overwritten in advance on the memory of the server 11.

(2) Only a pattern as a display result is extracted.

(3) Only the data is transmitted to the client 12.

(4) The client receives and displays the data.

In the above-mentioned process, in the case of the data denoted by the reference numeral 10 shown in FIG. 3, when the data is displayed in the order from 1 to 3, it is not necessary to transfer the second graphics as a display result, thereby 33% reducing the amount of image data to be transferred.

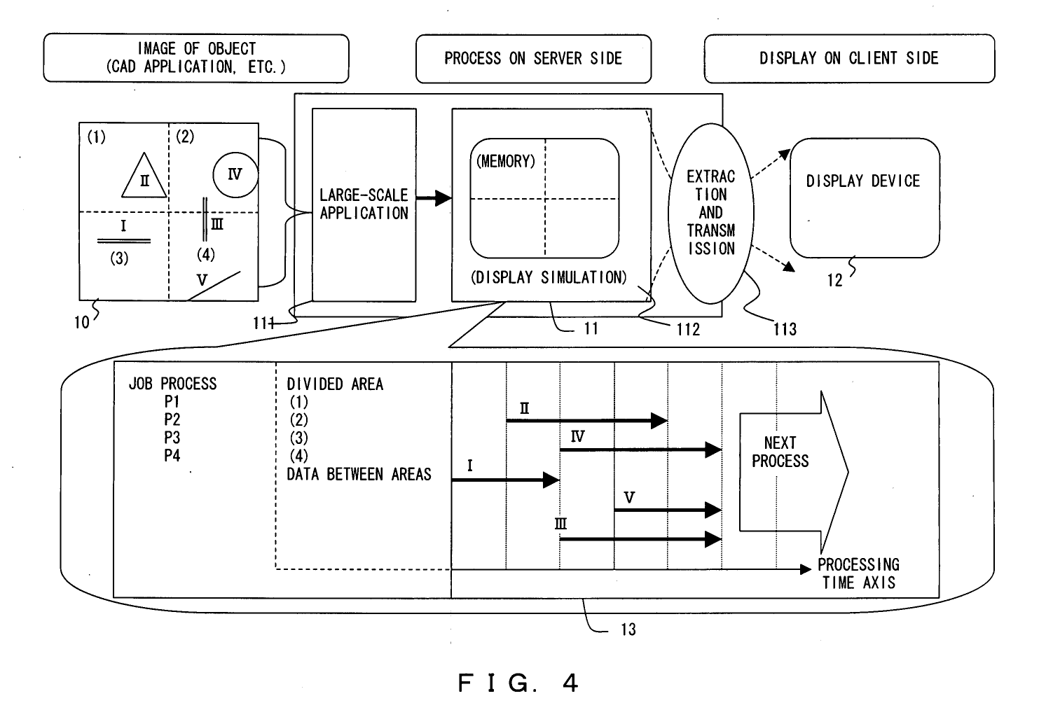

FIG. 4 shows the concept of performing the processes according to the first through third embodiments in parallel at a high speed.

A reference numeral 11 shown in FIG. 4 denotes a display simulation unit, and a reference numeral 13 shown in FIG. 4 is a time chart of job processes.

In this process, a process area is equally divided into four section areas for a high speed operation, and a job process (P1˜P4) is assigned to each divided area. Data covering areas between a plurality of divided areas is also assigned an exclusive job process P5, thereby retaining independence of each job process. In this process, the simulation process can be performed at a higher speed (2.6 times: 13/5). That is, when all processes are serially performed in the time chart denoted by the reference numeral 13 shown in FIG. 4, it takes 13 unit times indicating the total length of all arrows. However, in the present embodiment, the processes P1 through P5 are performed in parallel. Therefore, the process terminates in 5 unit times. Thus, the processing time can be shortened by performing each process in parallel while retaining the independence of each job process.

Since a display device denoted by a reference numeral 12 shown in FIG. 4 displays transmitted display data without overwriting data on the screen, a display result can be obtained at a high speed, and a user is allowed to visually recognize a displayed image at a higher speed.

In the example shown in FIG. 4, the following processes are performed.

(1) The display is equally divided into four areas.

(2) Each divided area is assigned a job process (P1˜P4).

(3) Additionally, a job process P5 is assigned to data covering areas between a plurality of divided areas.

By dividing a process into the above-mentioned job processes, the parallel process can be performed independently in each job process to process graphics I through V, and display data can be generated for a client at a high speed.

As a result, the total processing time (2.6 times: 13/5) indicates a high speed process.

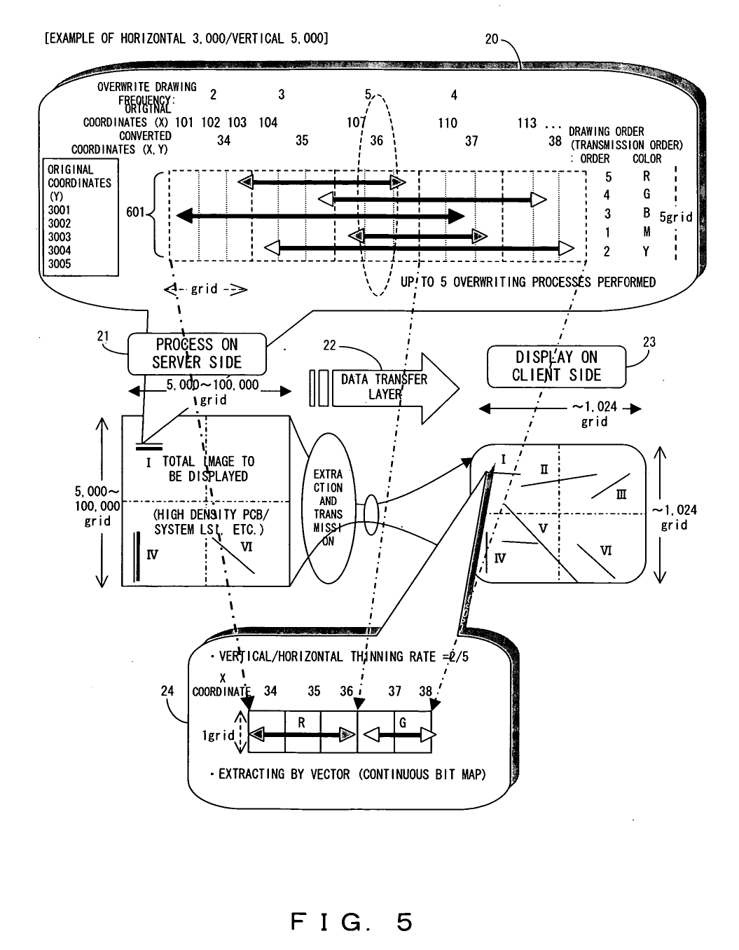

FIG. 5 is an explanatory view of a display simulation.

The process is performed as follows when data displayed on a high density printing plate, etc. as denoted by a reference numeral 20 shown in FIG. 5 is displayed on a display device of a client.

(1) The compression rate is computed with the resolution (display size) of a client 23 recognized (function called).

(2) Data up to the last data (until data is not received within a predetermined time) is overwritten (replaced on the coordinates of the memory) on the memory of the server 21 in advance.

(3) Only a pattern as a display result is extracted.

(4) Only the data is transmitted to the client 23.

(5) The client receives and displays the data.

In the above-mentioned process, when the data of a server is denoted by a reference numeral 20 shown in FIG. 5, that is, when the image data of the server 21 is configured by horizontal 5,000 grids and vertical 5,000 grids, and the client 23 is configured by 1,024×1,024 grids, the data of the client is represented such that the five lines of the data (20) on the server side 2 are reduced to the two lines of the data (24) on the client side 23 as shown in FIG. 5. Thus, the lines are 60% reduced.

That is, as denoted by the reference numeral 20 shown in FIG. 5, between the Y coordinates of 3001˜3005 and the X coordinates of 101˜113, five lines of R (Red), G (green), B (blue), M (magenta), and Y (yellow) are drawn on the server side. On the client side, these five lines are overwritten at the X coordinates of 34 through 38 at the Y coordinate of 601. Therefore, as denoted by the reference numeral 24 shown in FIG. 5, the data transmitted to the client is represented as 1 grid at the Y coordinate of 601 and the X coordinates of 34 through 36 as the line of R (red) and the X coordinates of 37 and 38 as the line of G (green) only.

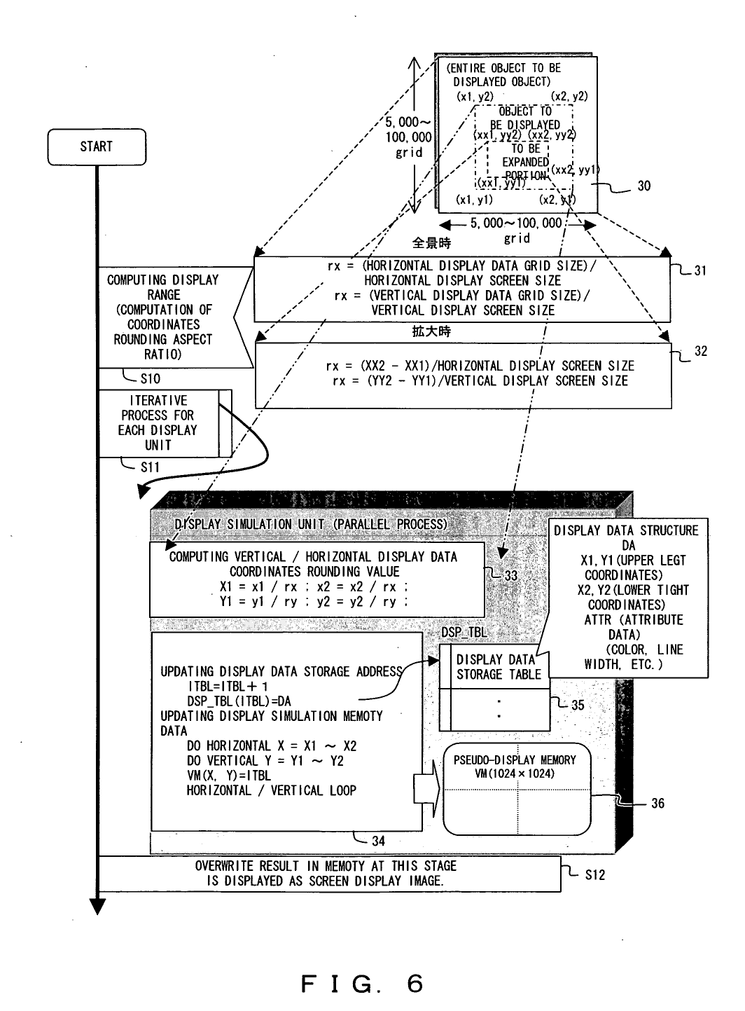

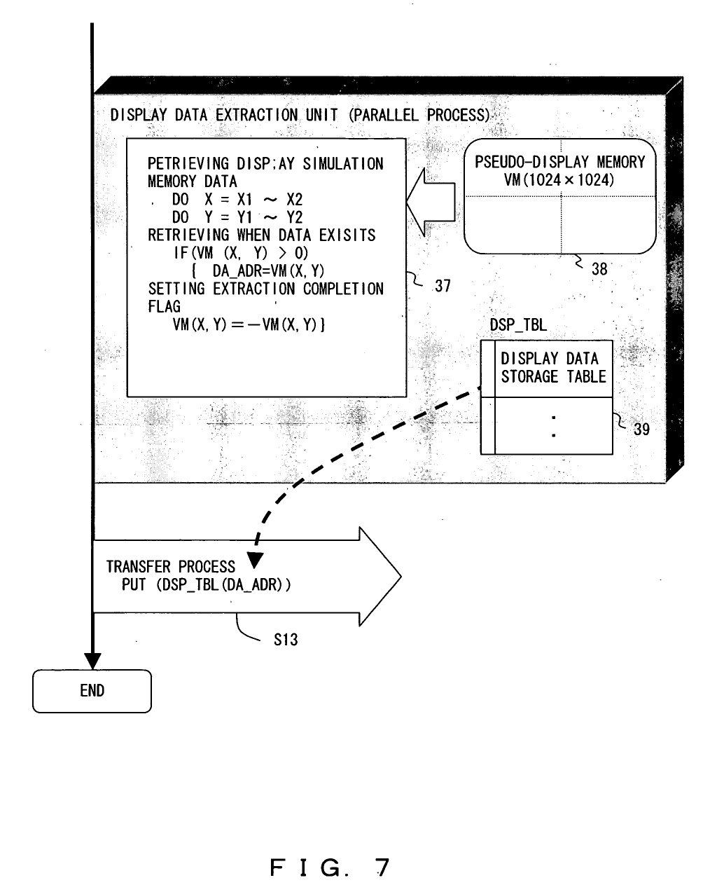

FIGS. 6 and 7 are flowcharts for explanation of the process according to an embodiment of the present invention.

First, in step S10, a display range is computed. That is, an aspect ratio is computed for rounding coordinates. An example of the computation is described in blocks denoted by reference numerals 30 through 32 shown in FIG. 6. That is, in the block 30 shown in FIG. 6, the image data formed by the vertical and horizontal 5,000˜100,000 grids on the server side is used as the entire object or image to be displayed or the server side has a horizontal display data grid size and a vertical display data grid size. The equation used when the entire object or image is displayed on the client side is indicated by the block 31 as follows.

rx=(horizontal display data grid size)/horizontal display screen size

ry=(vertical display data grid size)/vertical display screen size

Thus, the vertical and horizontal factors ry and rx are obtained.

When the user specifies a part of the screen to expand and display it, the vertical and horizontal factors ry′ and rx′ are obtained as follows as shown by block 32.
rx′=(xx2−xx1)/horizontal display screen size
ry′=(yy2−yy1)/vertical display screen size

The horizontal screen size and vertical screen size are the sizes of the display device on the client side, and the following data is presented.

Example of horizontal screen size:

common (1,024)/PDA (240)/mobile phone (176)

Example of vertical screen size:

common (768)/PDA (320)/mobile phone (200)

In step S11, an iterative process is performed for each display unit. An example of the process is indicated by blocks 33 through 36 shown in FIG. 6. That is, as indicated by the block 33, the display simulation unit computes a vertical/horizontal display data coordinate rounding value in a parallel process. An equation for computation of the rounding value is indicated by the block 33 as follows.
X1=x1/rx; X2=x2/rx;
Y1=y1/rx; Y2=y2/rx;

where X1, X2, Y1, and Y2 indicate rounding values. Therefore, the display simulation block 112 on the server side provides data obtained by reducing the entire object image by factors rx and ry so that data size on the display simulator block 112 corresponds t the size of the display on the client side. Thus, the reduced data is transmitted from the server side to the client side.

The method of performing the parallel process uses a parallel process compiler, a coding process, a vectorizer tool, etc.

The rounding values obtained by the above-mentioned equations are stored in a display data storage table denoted by the block 34. The ITBL in the block 34 indicates an address value of the display data storage table, DSP_TBL indicates a display data storage table, and DA indicates image data. The display data structure of the DA is formed by upper left coordinates (X1, Y1), lower right coordinates (X2, Y2), and attribute data. The attribute data includes a color, a line width, etc.

In the display simulation memory data update step denoted by the block 34, the pseudo-display memory 36 stores the contents of the display data storage table.

In step S12, the overwrite result at this stage is displayed as a screen display image.

As shown in FIG. 7, from pseudo-display memory 38, display simulation memory data is retrieved as shown by block 37. If data is detected, that is, if it is detected that an extracted flag VM (X, Y) is larger than 0 and indicates that the data extracting process has not been completed, then the value VM (X, Y) of the pseudo-display memory is written to DA_ADR. Then, the extracted flag is set. In this case, the VM is updated to a negative value. In step S13, a result obtained by setting the value of DA_ADR in the display data storage table DSP_TBL as shown in block 39 is transmitted to the client.

1. A high speed display processing system for simulating in advance at a high speed on a server side only display data which can be visually recognized as a server-side visual simulation, comprising:
a display data extraction unit extracting each display data element of a display data set in a system for a long-haul transmission of the display data set from a server to a client;
a higher display data subset extraction unit checking an overlap state between the display data elements, and extracting a portion of a higher display data element whose overlap state is to be displayed when the overlap state is detected;
a calculation unit compressing or expanding the higher display data element corresponding to a significant size and resolution of a display device of the client, and calculating in advance coordinates of a two-dimensional display image of each display data element;
a storage unit storing only visually recognized display data extracted using each of said units or composed by a calculation; and
a transmission unit transmitting the composite display data read by said recognition unit to the client.

2. A display processing apparatus which converts generated original image data and transmits the converted data to a display device, comprising:
an extraction unit extracting only a display result to be displayed on the display device as display data from the original image data; and
a transmission unit transmitting the display data to the display device.

3. The apparatus according to claim 2, wherein
said display data is roughly visualized from the original image data.

4. The apparatus according to claim 2, wherein
said extraction unit extracts data of three-dimensional graphics as the display data to be displayed on the display device in the three-dimensional graphics in the original image data.

5. The apparatus according to claim 2, wherein
said extraction unit divides the original image data into a plurality of areas, and allows a plurality of independent process units to process the areas, thereby performing extracting processes in parallel.

6. A storage medium storing a program used to direct a computer to convert generated original image data and transmit the converted data to a display device, comprising the steps of:
extracting step only a display result to be displayed on the display device as display data from the original image data; and
transmitting step the display data to the display device

7. The storage medium according to claim 6, wherein
said display data is roughly visualized from the original image data.

8. The storage medium according to claim 6, wherein
said extracting step extracts data of three-dimensional graphics as the display data to be displayed on the display device in the three-dimensional graphics in the original image data.

9. The storage medium according to claim 6, wherein
said extracting step divides the original image data into a plurality of areas, and allows a plurality of independent process units to process the areas, thereby performing extracting processes in parallel.

10. A display processing method for converting generated original image data and transmits the converted data to a display device, comprising the steps of:
extracting only a display result to be displayed on the display device as display data from the original image data; and
transmitting the display data to the display device.

11. The display processing method according to claim 10, wherein
said display data is roughly visualized from the original image data.

12. The display processing method according to claim 10, wherein
said extracting step extracts data of three-dimensional graphics as the display data to be displayed on the display device in the three-dimensional graphics in the original image data.

13. The display processing method according to claim 10, wherein
said extracting step divides the original image data into a plurality of areas, and allows a plurality of independent process units to process the areas, thereby performing extracting processes in parallel.
